(19) United States
(12) Patent Application Publication
(10) Pub. No.: US 2014/0120485 A1
(43) Pub. Date: May 1, 2014

(54) Furnace Assembly

(71) Applicant: IVOCLAR VIVADENT AG, Schan (LI)

(72) Inventor: Robert Grunenfelder, Eschen (LI)

(21) Appl. No.: 14/079,062

(22) Filed: Nov. 13, 2013

Related U.S. Application Data
(63) Continuation-in-part of application No. 12/291,357, filed on Nov. 7, 2008.

(30) Foreign Application Priority Data
Nov. 7, 2007 (DE) 102007053071.6

(51) Int. Cl. F27D 21/00; F27D 19/00

(52) U.S. Cl. CPC F27D 21/00; F27D 19/00
USPC 432/32; 432/51

(57) ABSTRACT

Provided are peptide analogues of PA-IL and compositions containing them. The PA-IL peptide analogues have altered carbohydrate binding specificity relative to a PA-IL of SEQ ID NO:1, and thus the analogues contain amino acid substitutions in SEQ ID NO:1. The substitutions can be at positions 50, 52 and 53 of SEQ ID NO:1 and can include combinations of amino acid substitutions at those positions. Also included are methods for detecting changes in the glycosylation of carbohydrates and for separating biomolecules which contain glycoproteins or glycoconjugates.

### CROSS-REFERENCE TO RELATED APPLICATIONS

This application is a continuation-in-part and claims priority to U.S. application Ser. No. 12/291357, filed Nov. 7, 2008, which claims foreign priority benefits under 35 U.S.C. 119(a)-(d) from German patent application ser. no. P 10 2007 053 071.6 filed Nov. 7, 2007, all of which are incorporated by reference herein.

### TECHNICAL FIELD

The invention relates to a furnace assembly including a control device having a data interface and a display device associated with the control device, and more particularly to a furnace assembly wherein a packet module is associated with the control device for transmitting data and/or images whereby in the case of an erroneous data transmission, it is not necessary to re-transmit all data but only the erroneous data packet.

### BACKGROUND OF THE INVENTION

Furnaces with the possibility of control by way of an external data source were already proposed some time ago, in particular for relatively large dental laboratories. Furthermore, it is known for furnaces to make the data transmission take place bidirectionally, that is to say for example always to signal the occurrence of data transmission or other signals from the furnace.

Furthermore, it was for example also proposed some time ago to signal the end of the firing process by way of a clear acoustic or optical signal, in order to signal to the employees in the dental laboratory the need to take action with respect to the furnace concerned.

An integrated solution in which a bidirectional interface is likewise realized was published not long ago, as can be seen from U.S. Pat. No. 7,001,178. This solution offers the possibility of sending control data, but also for example image data, to the furnace by way of a data input, it being conceivable to realize this by way of an RS-232 interface, a USB interface, or for example by way of a reader for memory cards or for chip cards.

In principle, it is possible specifically for relatively large amounts of data to transmitted quite quickly by way of the high-speed interfaces that are available. This also applies in particular to image data.

In order to keep down the costs of providing the furnace, it is in fact advisable to use the data input both for the transmission of control data and for the transmission of image data, for example for the presentation of images of teeth on the furnace or alongside the furnace. While the transmission of image data is less critical as far as data consistency is concerned, it is very important in the case of the transmission of control data that they are sent to the furnace in the correct form.

In order to ensure reliable data transmission, it is also known per se to add error correction, which aborts the data transmission when a transmission error occurs, and which automatically corrects the errors that may have occurred.

However, this type of data transmission has not become established in the case of furnaces, since, although all furnaces with a data input can receive data in a pure form, the error correction must in each case be coordinated between the receiver and the sender, so that the differences existing between the specific data formats that the furnace needs for its control data prevent the same control data format being used for all furnaces.

Therefore, nowadays control data are typically transmitted to furnaces specifically, and possibly even separately.

Furthermore, in the case of furnaces there is the problem that calibrations are required from case to case. This typically takes place by way of special calibrating programs, which then perform an adjustment between the set temperature and the actual temperature for the temperature curves being followed. Although it would be possible in principle to perform remote calibration, this is often not carried out because there is the risk of this causing errors—whether that of a furnace other than the one desired being calibrated or that of data errors occurring.

The manufacturers of dental ceramics also often develop new ceramics of their own, which use correspondingly adapted firing programs. In order to install these, the firing program concerned is typically fed into the furnace by way of a memory card or the like.

### OBJECTS AND SUMMARY OF THE INVENTION

According to the invention, it is envisaged to transmit both the control data for the furnace and any image data, if the furnace has a display device, in a particular way to the furnace. This involves dividing the data into packets, which each have an independent item of address information and at the same time have an error correction scheme. This then achieves the particularly favorable advantage when erroneous data are transmitted that only the erroneous packet has to be re-transmitted, but not the entire amount of data. This surprisingly has the particularly favorable effect that both quite small amounts of data of high quality—control data—and large amounts of data with lower quality requirements—image data—can be transmitted reliably and in conformity with the respective requirements of the furnace concerned, the use of the same standard surprisingly giving rise to the possibility of realizing the data transmission in the same way for different furnaces, even of different types, even if entirely different control data have to be transmitted.

According to the invention, it is accordingly envisaged to provide data packets of a prescribed length with a header or address bits, which make a unique assignment to the target furnace possible. To this extent, it is the responsibility of the sender of the data, that is for example also the manufacturer of the furnace, to perform the assignment between the control data and the address data correctly. The transmission consequently takes place independently of the quality of the data transmission path, the detection of an erroneous packet resulting in this being signalled and re-transmission of the same data packet being requested.

The length of the data packets can be adapted to the requirements within wide ranges. With preference, a uniform, average packet length is chosen, for example 2 kB. However, it is also possible, and advisable specifically in the case of poorer quality of the data transmission path, to realize a comparatively short packet length such as 512 bits, which is particularly suitable for the transmission of control data. The transmission times of the image data are prolonged for understandable reasons in the case of a reduced data packet length, in accordance with the ratio between payload and overhead data, that is those data that serve for addressing the packet concerned and also for the error checking or error correction, so that in the case of smaller packets an increased amount of data must be transmitted.

This is advisable in particular if a wireless transmission technique is chosen for the transmission path, such as for example by the installation of a GRPS, EDGE or UMTS module, or possibly an HSDPA module, the reduction of the payload transmission rate in relation to the gross data transmission rate becoming ever less critical with increasing speed of the data transmission path.

Alternatively or an addition, it is also possible to operate the furnace by way of an Internet connection and to make the packets take the form of IP packets. The control may then also be performed by way of a web browser, it being possible for the data interface to be realized in any suitable way desired, for example also by way of a LAN which is connected to the Internet by means of a router.

In this case, it is also possible to perform the control or programming of the furnace remotely by way of a VPN or SSH connection.

According to the invention, it is particularly favorable in this context if an image of the screen of the furnace can be shown on a remote screen, for example on that of a cellphone, in a form of reduced resolution, by way of a long-distance data connection. If a touch-sensitive screen is used as the screen, this can be simulated for example by way of a smart phone or a PDA, it also being possible to realize the remote control by means of a customary cursor control by way of a joystick, arrow keys or the like.

According to the invention, it is accordingly provided that the control device of the furnace has a packet module, which provides the correct dividing up and putting together of data from and into packets. This includes, for example, an IP module, but also alternatively an EDGE, GRPS or UMTS module.

In an advantageous refinement of the invention, it is envisaged to perform the data transmission between the furnace and a remote station, which may for example be a cellphone or a remote PC, in an encrypted form. This ensures that no manipulations can be carried out by third parties, which is conducive to the security of the transmission and consequently to the security of the remote control of the furnace.

Furthermore, it is particularly favourable that a modular structure is ensured by the realization of a particular packet module that provides the data transmission function. Such a packet module can accordingly also be used in the case of different furnaces; retrofitting of furnaces with the packet module is also possible.

It is also possible to use the same packet module in different furnaces, namely those for which a screen is provided and those for which no screen is provided. When screenless furnaces are used, the packet module is to this extent used for providing the control data.

According to the invention, it is provided that the image data are transmitted by way of a long-distance data transmission channel, which operates in particular bidirectionally.

In a further advantageous refinement, it is provided that the receiving format of the control device for the data corresponds to the transmitting format of an SMS for the control data and/or the transmitting format of an MMS for the image data.

In a further advantageous refinement, it is provided that the control data are automatically separated from the image data on reception in the furnace.

In a further advantageous refinement, it is provided that the image data have or are accompanied by identification data, with which information on the image data concerned can be transmitted simultaneously with the transmission of static images or moving images, in particular films.

In a further advantageous refinement, it is provided that confirmation information on the firing process in the furnace and/or the orders processed and/or the tooth colors used and/or further dental parameters can be transmitted, in particular to the client, by way of the data interface of the furnace.

In a further advantageous refinement, it is provided that each packet of the image data has an item of information on its target address, namely the furnace.

In a further advantageous refinement, it is provided that the display device, in particular a screen of the furnace, has at least one touch-sensitive region, by way of which keyboard functions can be transmitted to the control device of the furnace.

In a further advantageous refinement, it is provided that the furnace has a loudspeaker and/or a microphone, by way of which the furnace operates in the manner of a cellphone, and that the control device has in particular an SMS function and/or an MMS function, by way of which text messages and/or image data can be sent from the furnace.

In a further advantageous refinement, it is provided that information for an update can be transmitted to the control device by way of the packet module.

In a further advantageous refinement, it is provided that it is possible while the furnace is being operated to switch on a help mode, by way of which information and data for operating the furnace can be transmitted, in particular wirelessly, to the corresponding furnace and can be displayed on the screen.

In a further advantageous refinement, it is provided that the furnace can be remotely controlled by way of the data interface and the packet module.

In a further advantageous refinement, it is provided that an operator interface of the remote control can be displayed on the screen of the furnace.

In a further advantageous refinement, it is provided that the data transmission itself has an error correction and, when erroneous data are detected, only these are re-transmitted.

In a further advantageous refinement, it is provided that the error correction and/or an error check takes place exclusively on the level of the data transmission, that is to say the control data themselves are transmitted without a check bit or the like.

In a further advantageous refinement, it is provided that the control data have address information, which defines how the furnace that is respectively to be controlled is to be addressed.

In a further advantageous refinement, it is provided that the touch-sensitive region of the screen also has cursor control functions, by way of which cursor function positioning of objects on the screen can also be realized.

### BRIEF DESCRIPTION OF THE FIGURES

Further advantages, details and features emerge from the following description of an exemplary embodiment on the basis of the drawing, in which:

FIG. 1 shows a schematic representation of a furnace according to the invention in one embodiment;

FIG. 2 shows a modified embodiment of the furnace according to FIG. 1.

FIG. 3 shows an embodiment of the furnace according to the invention.

### DETAILED DESCRIPTION

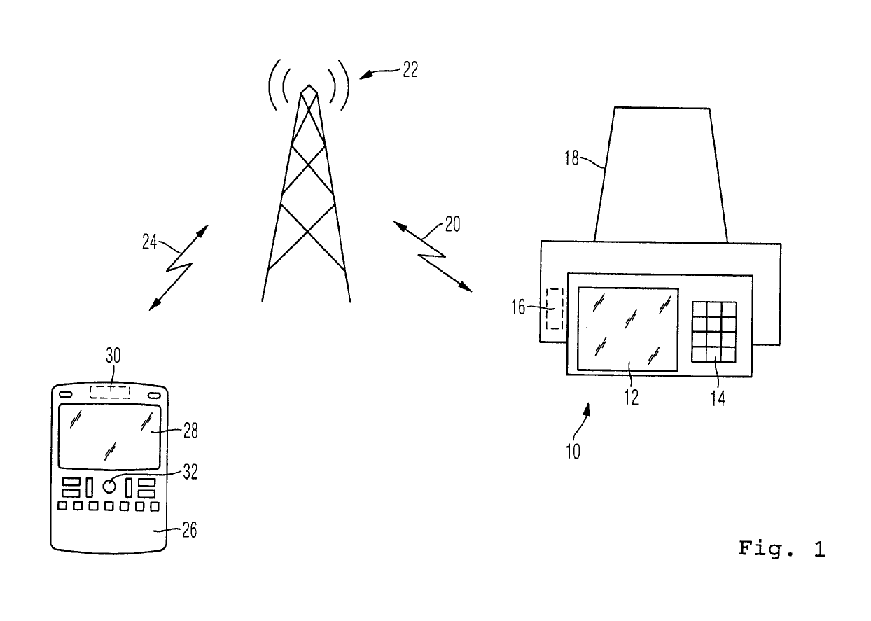

The furnace assembly 10 represented in FIG. 1 has a display device 12, on which signals and data concerning the furnace, such as for example furnace parameters, can be presented in a way known per se. The choice of presentation and the direct control of the furnace likewise take place in a way known per se. If the display device 12 has a touch-sensitive screen, the control can be performed directly there. In the exemplary embodiment represented, a keyboard 14 is provided, by way of which the control takes place in a display-related manner, for example by arrow keys being used to move a cursor and the desired function being initiated.

In addition, the display device 12 is capable of presenting images of dental restoration parts and/or teeth of patients. The data concerned can be readily produced from photographs of neighboring teeth of the tooth to be created, it being possible for example to set the choice of which detail is presented on the screen.

According to the invention, a packet module 16, which according to the invention makes the data exchange possible in a special way, is provided in the furnace. The packet module 16 is part of a control device 18 of the furnace that is intended for providing the firing curves etc. and also ensures that the furnace parameters of a firing process that are prescribed by way of the keyboard 14 and displayed on the display device 12 are maintained.

Even if the packet module 16 is represented here as part of the control device 18, this relates in principle to the logical assignment of the packet module 16 to the control device 18. Accordingly, a physical separation is also possible, for example in that the packet module 16 is connected to the furnace assembly 10 as a kind of adapter. Combination with a modem is also possible.

The packet module 16 allows packet transmission of data by way of a transmission path 20. In the exemplary embodiment represented, electromagnetic waves are provided as the medium, transmitted in the form of GRPS data by way of a base station 22 with a corresponding antenna. The data are transmitted by way of a corresponding transmission path 24 to and from a cellphone 26, which has a comparatively large screen 28 for the visual presentation of suitable signals. For example, the screen 28 of the cellphone 26 may be designed as a reduced copy of the display device 12, or certain selected data may be displayed in a compact form.

The cellphone 26 has a mobile module 30, which undertakes the preparation of the packet data and to this extent is compatible with the packet module 16. The data are transmitted together in packets, each with address information and error correction data, so that a reliable data transmission can be realized even in the case of poor transmission quality of the transmission path.

Even if electromagnetic waves are envisaged here as the primary transmission medium, it goes without saying that any other suitable data medium desired may be provided. For example, the realization of LAN connections comes into consideration. If, for example, a WLAN or a LAN connection is used, a PC, which possibly can be connected to the packet module 16 by way of a router and the Internet, may be used instead of the cellphone 26 as the controlling terminal.

During the operation of the furnace according to the invention, the furnace assembly 10 can be controlled by way of the cellphone 26, using its cursor that can be controlled by way of a joystick 32, with the presentation of the display taking place in parallel on the screen 28 and the display device 12. It is also possible to provide what is known as a master function, with which, for example, the manufacturer of the furnace or a competent technical adviser shows the dental technician the possibilities and settings. In this case, control of the furnace assembly 10 by way of the cellphone 26 has priority over operation by way of the keyboard 14.

It is also possible for example by way of the cellphone to transmit the desired images in the form of an MMS; the control data may also be transmitted for example in the form of an MMS, and also a software update can be readily realized for example by way of a JAVA program.

The same applies correspondingly if a PC is used as the device: in this case, the transmission of new firing parameters, for example for a newly developed ceramic, is possible extremely easily, and it is also ensured by the error-corrected packet data transmission that incorrect furnace control does not occur.

Furthermore, there is also the possibility of performing a remote calibration or even remote maintenance with functional checking of the furnace control.

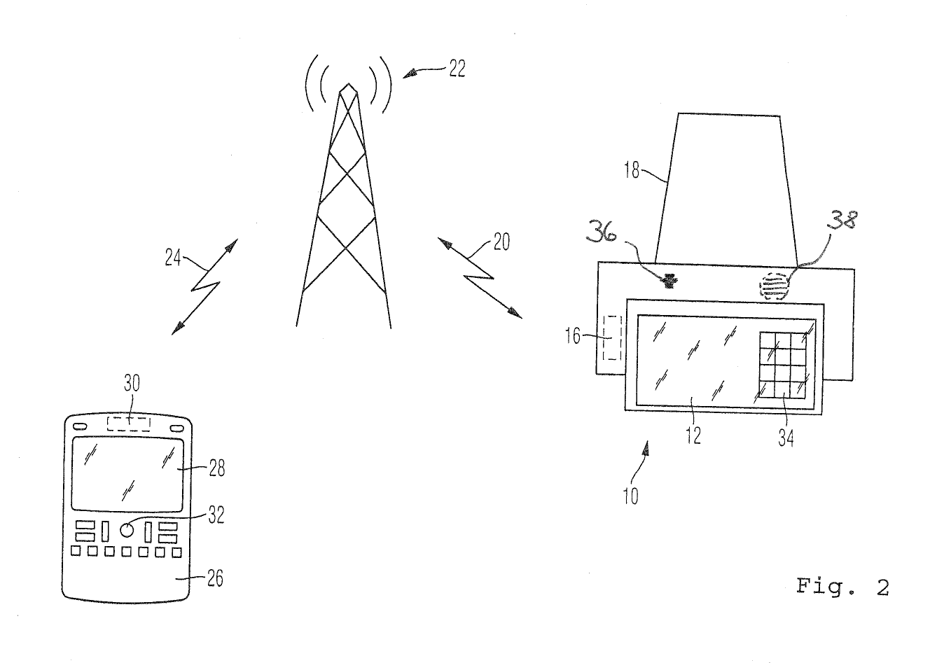

The embodiment of the furnace that is represented in FIG. 2 differs from that according to FIG. 1 in that an enlarged screen is provided as the display device 12 on the furnace assembly 10. At least part of the screen is formed in a touch-sensitive manner as what is known as a touchscreen 34, it being possible to use this touch-sensitive region for initiating both keyboard functions and, for example, cursor functions. Cursor functions can be initiated for example by the user moving a finger in a specific direction.

In one especially preferred embodiment the dental furnace 10 comprises a communication component which is connected either to the public switched telephone system (PSTN, land line) via a conventional telephone cable or fixed telephone line, to a mobile network (GSM, UMTS/3G or CDMA, 4G LTE) via a mobile communication device in connection with an appropriate SIM card, or to a data network (Internet/IP, Intranet, etc.) via wired or wireless technology (LAN, WLAN/WiFi), in order to communicate with a respective remote terminal (e.g. via skype, MS messenger, etc.).

In order to provide the required interface for connecting the dental furnace either to the analog public switched telephone network (PSTN) which is commonly referred to POTS (plain old telephone system), or to connect it to the digital ISDN (integrated services digital network) the dental furnace comprises a telephony interface 46 which provides the respective termination for analog (POTS) or digital (ISDN) and lines, in order to enable the operator of the dental furnace to communicate with a remote person using a remote terminal such as a telephone, a similar dental furnace or any suitable device being connected to the public switched telephone network (PSTN). Even though the telephony interface 46, in its simple form, shall be adapted either to be connected to an analog (POTS) or digital (ISDN) telephony network the telephony interface 46 can also comprise both interfaces (analog, ISDN), in order to use the inventive dental furnace in any environment regardless of the fact whether an analog or digital subscriber line will be available.

Furthermore, the inventive dental furnace may also comprise means for wireless communication over cellular telephone networks such as GSM, UMTS/3G, CDMA, 4G LTE or the like. Therefore, a respective wireless communication means is provided. A common SIM card 50 (subscriber Identification module) is provided for enabling wireless connection of the dental furnace via one or more of the aforementioned wireless communication networks as it is well known from cellular telephony. Except for the physical connection (wireless rather than line-based) for the communication of the operator the same applies as already said above regarding the telephony interface 46.

Moreover, communication can also be accomplished by using voice over internet protocol (VoIP). Therefore, the dental furnace is equipped with a suitable network interface for LAN (local area network) with connection to the internet such as twisted pair cabling or Wi-Fi. A suitable software running on the dental furnace is controlling the desired connection to the remote partner, e.g. via skype. The audio signals of the communication are coded and decoded by siad software, in order to be tranported using the internet protocol (IP) in a manner known per se.

The dental furnace 10 further comprises a loudspeaker 38 which is intended to output incoming speech signals (from the remote terminal), and still further comprises a microphone 36 which serves to receive the acoustic signals (speech) of the operator of the dental furnace 10, in order to transmit operator's speech to the remote terminal. The loudspeaker 38 and the microphone 36 are each connected to a hands-free communication device which allows communication of the operator (dentist, technician) with its (remote) dialog partner (technician or dentist, respectively) without the need of a conventional telephone receiver or any similar external speech input/output unit. Thus, any handling of the operator at the dental furnace 10 can be avoided, especially if the operator's hands otherwise would needed to be cleaned, or if the operator immediately needs both hands to operate the dental furnace or is otherwise busy.

By means of symbols or soft keys displayed on the touch screen 34 which is also at least by means of the control device 18, connected to the hands-free communication device 44. The operator is enabled to operate the hands- free communication device in a manner known per se. Insofar as controlling of establishing or completing a connection/call, inputting the call destination (dialing a telephone number, scrolling through telephone directory/numbers stored in the communication control component) is possible by means of the touch screen 34.

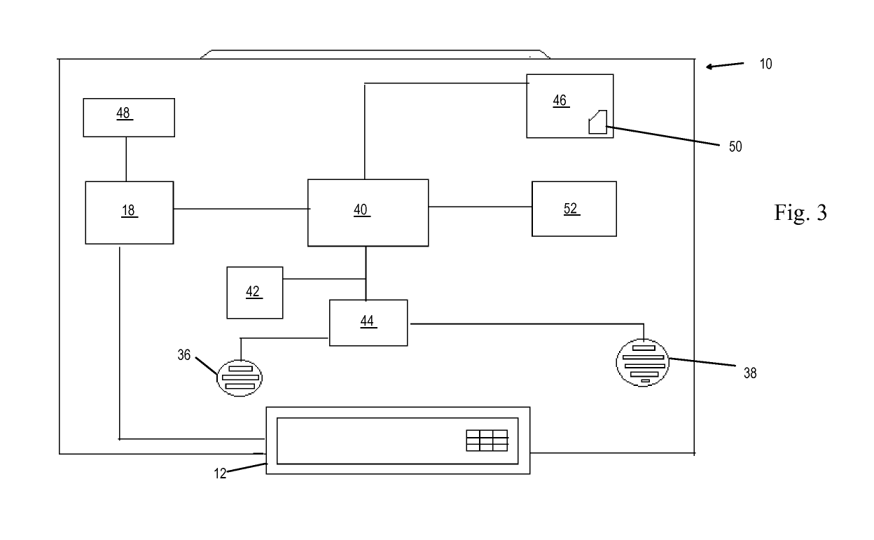

FIG. 3 shows an embodiment of furnace 10 of the invention. Furnace 10 includes a control device 18 and a communication control device 40. The communication control device can be, for example, a voice recognition component 42, which is connected to the control device 18 of the dental furnace 10.

By means of the communication control device, in connection with the voice recognition means 42, the operator is able to operate the dental furnace 10 just by spoken words (commands) whereas the operator's voice is received by the microphone 36, and the thus generated electrical signals are transferred to the voice recognition component which in turn forwards respective control commands to the control device of the dental furnace 10. Thus, voice control of the dental furnace 10 can be accomplished which contributes to a hands-free operation of the complete dental furnace 10 such that the operator can use his hands for other important tasks while simultaneously operating the dental furnace 10.

Furthermore, any contamination of the touch screen 34 can be avoided since touching it is not necessary anymore. Moreover, operating the dental furnace 10 is even possible without the need to take off gloves (if the dentist/technician prefers to wear some) since conventional touch screens need to be operated by bare fingers due to the capacitive or resistive functional principles of recent touch sensitive surfaces. Accordingly, a significant increase of efficiency and simplification of the operation of the inventive dental furnace 10 can be achieved by the voice control feature.

Another feature of an embodiment allows the operator to record and store voice notes by means of the microphone 36 and the hands-free communication device 44 which further comprises a memory component 52 being capable of storing audio data. These stored voice notes can be played back by means of the loudspeaker 38. The control of recording and playing the voice notes as well as displaying the stored notes (and the remaining memory capacity, etc.) is also achieved by means of the touch screen 34 in a manner known per se.

In a still further preferred embodiment the control device of the dental furnace 10 further comprises a memory component 48 which is capable of storing parameters of previously processed dental restoration parts. These parameters can be stored in the form of a data base and can e.g. be associated with individual operators or even patients for whom the dental restoration parts were made. Thus, the stored previous processes can be sorted by operators and/or patients and can be displayed or filtered. Respective identification can be achieved by inputting e.g. the name of the operator or patient on the touch screen 34 in a manner known per se, or in any other suitable manner. In particular, identification of the operators can also be achieved by means of e.g. a chip card or an RFID chip whereas a respective reader has to be arranged on the dental furnace 10.

The storage component 48 for storing the parameter as mentioned above can either be embodied as an individual means such as a RAM (random access memory) module, hard disc drive (HDD) or any suitable memory or can be an integral component of the control means 18. In one preferred embodiment it is also possible to store the parameters on an external means such as a FLASH memory stick or an external HDD. It could also be possible to copy the parameters stored on an internal memory onto an external memory, in order to use the parameters stored on a different dental furnace.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A furnace for dental technology for processing ceramic compositions comprising:
a display device (12),
a control device (18) associated with the display device,
a communication control device (40),
a telephony interface device (46),
a loudspeaker (38),
a microphone (36), and
a hands-free communication component (44),
wherein the control device (18) has an interface to the communication control device (40), and
wherein the communication control device (40) is further connected to the telephony interface device (46).

2. The furnace according to claim 1, wherein the display device comprises a touch screen (34).

3. The furnace according to claim 1 wherein the telephony interface is capable of communicating via a PSTN (land line), via wireless communication network by a SIM card (50) installed in the telephony interface (46) and/or a data cable.

4. The furnace according to claim 3, wherein the wireless communication network comprises GSM, UMTS, CDMA or 4G LTE.

5. The furnace according to claim 3 wherein the telephony interface via data cable communicates using Voice over IP (VOIP) telephony and/or Skype.

6. The furnace according to claim 1, further comprising a voice recognition component (42) whereas the voice recognition component is connected to the communication control device (40) and further to the control device (18) and whereas the voice recognition component is able to recognize spoken commands which are input by component of microphone (36) via the communication control device (40) and/or the hands-free communication component (44) and whereas the control device (18) is able to control the operation of the furnace responsive to the spoken commands recognized by the voice recognition component (42).

7. The furnace according to claim 1 further comprising a voice note storing device (52), wherein the voice notes can be input by the microphone and can be output by the loudspeaker.

8. The furnace according to claim 1 further comprising a storage component (48) for storing data of previously finished processes.

9. The furnace according to claim 8, wherein the storage component (48) is in the form of a data base.

10. The furnace according to claim 8 whereas the data of the previously finished processes can be associated with different users, operators and/or patients.

11. The furnace according to claim 1, wherein the control device (18) has a data interface by which data for controlling the furnace assembly and/or image data in the form of static images or moving images can be transmitted.

12. The furnace according to claim 1, wherein the control device (18) comprises a packet module (16), by which control data and/or image data for presentation on the display device (12) can be transmitted in the form of data packets.

13. The furnace according to claim 12, wherein the packet module comprises an EDGE, GSM, GRPS and/or UMTS module.

14. The furnace according to claim 12, wherein the image data are transmitted by way of a long-distance data transmission channel, which operates bidirectionally.

15. The furnace according to claim 12, wherein receiving format of the control device (18) for the data corresponds to the transmitting format of an SMS for the control data and/or the transmitting format of an MMS for the image data.

16. The furnace according to claim 12, wherein the control data is automatically separated from the image data on receipt in the furnace assembly (10).

17. The furnace according to claim 12, wherein the image data is accompanied by identification data, with which information on the image data concerned can be transmitted simultaneously with the transmission of static images or moving images.

18. The furnace according to claim 11, wherein confirmation information on the firing process in the furnace and/or orders processed and/or tooth colors used and/or further dental parameters can be transmitted to the client, by way of the data interface of the furnace.

19. The furnace according to claim 11, wherein the image data is in the form of a packet and wherein each packet has an item of information on a target address of the furnace.

20. The furnace according to claim 1, wherein the display device (12) comprises a screen and has at least one touch-sensitive region (34), by which keyboard functions can be transmitted to the control device (18). stopped

21. The furnace according to claim 1, wherein the furnace assembly (10) operates in the manner of a cellphone (26), and wherein the control device (18) has in particular an SMS function and/or an MMS function, by way of which text messages and/or image data can be sent from the furnace assembly (10).

22. The furnace according to claim 1, wherein information for an update can be transmitted to the control device (18) by way of the packet module (16).

23. The furnace according to claim 1, wherein it is possible while the furnace assembly (10) is being operated to switch on a help mode, by way of which information and data for operating the furnace assembly can be transmitted wirelessly, to the corresponding furnace assembly (10) and can be displayed on a screen (28).

24. The furnace according to claim 12, wherein the furnace assembly (10) can be remotely controlled by way of the data interface and the packet module (16).

25. The furnace according to claim 1, wherein an operator interface of a remote control can be displayed on a screen (28) of a cell phone and simultaneously on display device 12 of the furnace .

26. The furnace according to claim 12, wherein the image data transmitted has an error correction and when erroneous data are detected only the corrected data are re-transmitted.

27. The furnace according to claim 12, wherein the control data have address information, which defines how the furnace to be controlled is to be addressed.

28. The furnace according to claim 20, wherein the touch-sensitive region of the screen (34) has cursor control functions by which objects on the screen can positioned by the cursor control functions.
